(19) United States
(12) Patent Application Publication
(10) Pub. No.: US 2012/0270720 A1
(43) Pub. Date: Oct. 25, 2012

(54) DIELECTRIC CERAMIC-FORMING COMPOSITION AND DIELECTRIC CERAMIC MATERIAL

(75) Inventor: Shinji Tanabe, Tokyo (JP)

(73) Assignee: Nippon Chemical Industrial Co., Ltd, Tokyo (JP)

(21) Appl. No.: 13/501,832

(22) PCT Filed: Oct. 15, 2010
(86) PCT No.: PCT/JP2010/068169

§ 371 Date: Jun. 27, 2012

(30) Foreign Application Priority Data
Oct. 16, 2009 (JP) 2009-239495

(51) Int. Cl. C04B 35/468

(52) U.S. Cl. 501/138; 501/134

(57) ABSTRACT

A dielectric ceramic-forming composition comprising a perovskite (ABO₃)-type ceramic raw material powder, and a glass powder containing, on an oxide basis, 35% by weight to 90% by weight of Bi₂O₃, 2.5% by weight to 20% by weight of ZnO, 1% by weight to 20% by weight of B₂O₃, 0.5% by weight to 15% by weight of SiO₂, 0.5% by weight to 15% by weight of an alkali metal oxide, and 0.1% by weight to 35% by weight of an alkaline earth metal oxide, wherein 1% by weight to 15% by weight of the glass powder is blended with respect to the dielectric ceramic-forming composition, which can be fired at temperature lower than conventional temperature and can provide a dielectric ceramic material having high relative permittivity.

### TECHNICAL FIELD

The present invention relates to a dielectric ceramic-forming composition that can be sintered at low temperature, and a dielectric ceramic material obtained by firing the same.

### BACKGROUND ART

Perovskite-type ceramics are used as electronic materials such as dielectric materials for multilayer capacitors and the like, piezoelectric materials, and semiconductor materials. As a typical perovskite-type ceramic, barium titanate is well known.

In recent years, the demand for the miniaturization of electronic components has increased, and with this, a dielectric ceramic sintered body layer constituting an electronic component has become thinner. In order to make the thickness of the sintered body layer thin, it is necessary to decrease the particle diameter of crystal particles in the dielectric ceramic sintered body layer. Generally, when sintering is performed at high temperature, crystal particles grow. Therefore, it is strongly demanded that raw material powders, such as barium titanate, can be sintered at low temperature.

Conventionally, as a method for producing a barium titanate powder, a solid-phase method in which a uniform mixture of a titanium oxide powder and a barium carbonate powder is heated to a high temperature of 1300° C. or higher for a solid-phase reaction has been known. However, disadvantages of the solid-phase method are that uniform fine particles are not easily obtained, and sintering is difficult at low temperature. On the other hand, characteristics of a wet method are that uniform fine particles are easily obtained, and moreover, the obtained barium titanate powder is easily sintered at low temperature, compared with the solid-phase method. Therefore, the wet method is expected as a method for producing a barium titanate powder for low-temperature sintering. As such a wet method, specifically, (1) an oxalate method in which TiCl₄, BaCl₂, and oxalic acid are reacted in an aqueous solution to form a precipitate of BaTiO(C₂O₄)₂.4H₂O, and then, the formed precipitate is pyrolyzed, (2) a hydrothermal synthesis method in which a mixture of barium hydroxide and titanium hydroxide is hydrothermally treated, and the obtained reaction product is calcined, (3) an alkoxide method in which a mixed alkoxide solution of barium alkoxide and titanium alkoxide is hydrolyzed, and the obtained hydrolysate is calcined, (4) an atmospheric-pressure heating reaction in which a reaction product obtained by the hydrolysis of titanium alkoxide in an aqueous solution of barium hydroxide is calcined, and the like are proposed.

However, although the sintering temperature of barium titanate powders obtained by these wet methods can be somewhat lower than that of a powder obtained by the solid-phase method, a problem is that the sintering temperature is a high temperature of 1200° C. or higher, and sintering at lower temperature is difficult.

Therefore, various methods for obtaining perovskite-type ceramics that can be fired at lower temperature are proposed. For example, one containing 95% by weight to 99.0% by weight of barium titanate and 1.0% by weight to 5.0% by weight of lithium fluoride (for example, see Patent Literature 1), one containing an alkali metal component and at least one of a niobium component, an alkaline earth metal component, a bismuth component, a zinc component, a copper component, a zirconium component, a silicon component, a boron component, and a cobalt component as accessory components in barium titanate (for example, see Patent Literature 2), one containing a perovskite (ABO₃)-type ceramic raw material powder having an average particle diameter of 0.01 to 0.5 μm and a glass powder having an average particle diameter of 0.1 to 5 μm, in which the blending amount of the glass powder is 3% by weight to 12% by weight (see Patent Literature 3), and the like are proposed. But, the development of materials that can be fired at lower temperature and have high permittivity has been desired.

### CITATION LIST

### Patent Literature

Patent Literature 1: Japanese Patent Laid-Open No. 62-20201
Patent Literature 2: Japanese Patent Laid-Open No. 2002-173368
Patent Literature 3: Japanese Patent Laid-Open No. 2006-265003

### SUMMARY OF INVENTION

### Technical Problem

Therefore, it is an object of the present invention to provide a dielectric ceramic-forming composition that can be fired at temperature lower than conventional temperature and can provide a dielectric ceramic material having high relative permittivity, and a dielectric ceramic material using the same.

### Solution to Problem

The present inventors have made diligent studies to solve the above problem, and, as a result, found that one in which a specific amount of a glass powder comprising Bi, Zn, B, Si, an alkali metal, and an alkaline earth metal in a specific proportion is blended in a perovskite (ABO₃)-type ceramic raw material powder is easily sintered even at a low temperature of about 650° C. to 900° C., and even one sintered at such a low temperature provides a dielectric ceramic material having high relative permittivity, leading to the completion of the present invention.

In other words, a dielectric ceramic-forming composition according to the present invention is a dielectric ceramic-forming composition comprising a perovskite (ABO₃)-type ceramic raw material powder, and a glass powder containing, on an oxide basis, 35% by weight to 90% by weight of Bi₂O₂, 2.5% by weight to 20% by weight of ZnO, 1% by weight to 20% by weight of B₂O₂, 0.5% by weight to 15% by weight of SiO₂, 0.5% by weight to 15% by weight of an alkali metal oxide, and 0.1% by weight to 35% by weight of an alkaline earth metal oxide, wherein 1% by weight to 15% by weight of the glass powder is blended with respect to the dielectric ceramic-forming composition.

A dielectric ceramic material according to the present invention is obtained by firing the above-described dielectric ceramic-forming composition.

### Advantageous Effect of Invention

Even if the dielectric ceramic-forming composition according to the present invention is sintered at temperature lower than conventional temperature, a dielectric ceramic material having high relative permittivity can be obtained. For example, the obtained dielectric ceramic material can not only be used as dielectric materials for thin-layer ceramic capacitors, but can also be preferably used as dielectric materials for electronic components, such as printed wiring boards, multilayer printed wiring boards, electrode ceramic circuit boards, glass ceramic circuit boards, circuit peripheral materials, inorganic ELs, and plasma displays.

### DESCRIPTION OF EMBODIMENT

The present invention will be described below based on a preferred embodiment thereof.

As a perovskite (ABO₃)-type ceramic raw material powder used in the dielectric ceramic-forming composition of the present invention, one in which the A-site element is at least one metal element selected from the group consisting of Ca, Sr, and Ba and the B-site element is at least one selected from the group consisting of Ti and Zr is preferred in terms of obtaining a dielectric ceramic material having high relative permittivity. Examples of such a preferred perovskite (ABO₃)-type ceramic include barium titanate, calcium titanate, strontium titanate, barium calcium zirconate titanate, barium zirconate titanate, barium strontium titanate, barium zirconate, calcium zirconate, strontium zirconate, barium calcium zirconate, barium strontium zirconate, and calcium strontium zirconate. One of these may be used alone, or two or more of these may be used in combination. Among these, barium titanate is most preferably used in terms of obtaining a dielectric ceramic material having higher relative permittivity by low-temperature firing.

In addition, the average particle diameter of the perovskite-type ceramic raw material powder is preferably 0.1 μm to 2 μm, more preferably 0.2 μm to 1.5 μm. The average particle diameter of the perovskite-type ceramic raw material powder in the range is preferred because the intrinsic electrical characteristics, sintering characteristics, and handling characteristics of the particles are good. The average particle diameter of the perovskite-type ceramic raw material powder in the present invention is a value obtained from a particle diameter D50 in volume distribution measurement using a laser diffraction method.

In addition, the BET specific surface area of the perovskite-type ceramic raw material powder is preferably 1.0 m²/g or more, more preferably 1.0 m²/g to 10 m²/g. The BET specific surface area in the range is preferred because the sinterability and the handling properties are good, and a dielectric ceramic material having stable quality is obtained.

In the present invention, two or more perovskite-type ceramic raw material powders different in physical properties, such as average particle diameter and BET specific surface area, may be used.

The method for preparing the perovskite-type ceramic raw material powder is not particularly limited and examples thereof include wet methods, such as a coprecipitation method, a hydrolysis method, a hydrothermal synthesis method, and an atmospheric-pressure heating reaction method, or a solid-phase method. In addition, commercial perovskite-type ceramic raw material powders may be used.

The glass powder used in the dielectric ceramic-forming composition of the present invention has one feature in its composition.

In other words, the composition of the glass powder is, on an oxide basis, 35% by weight to 90% by weight, preferably 40% by weight to 80% by weight, of Bi₂O₃, 2.5% by weight to 20% by weight, preferably 5% by weight to 10% by weight, of ZnO, 1% by weight to 20% by weight, preferably 5% by weight to 15% by weight, of B₂O₂, 0.5% by weight to 15% by weight, preferably 1% by weight to 10% by weight, of SiO₂, 0.5% by weight to 15% by weight, preferably 1% by weight to 12% by weight, of one or more oxides of alkali metals selected from the group consisting of Li, Na, and K, and 0.1% by weight to 35% by weight, preferably 3% by weight to 25% by weight, of one or more oxides of alkaline earth metals selected from the group consisting of Mg, Ca, Sr, and Ba. By adding and mixing the glass powder having a composition in such a range to the perovskite (ABO₃)-type ceramic raw material powder, firing can be performed even at low temperature, particularly about 700° C., and a dielectric ceramic material having high relative permittivity can be provided.

Further, in the present invention, when the above-described glass powder further contains, on an oxide basis, 0.1% by weight to 5% by weight, preferably 0.2% by weight to 2% by weight, of CuO, firing can be performed at lower temperature, and a dielectric ceramic material having high relative permittivity can be provided.

The glass powder in the present invention may comprise, in addition to the above-described components, a small amount of components to the extent that the effect of the present invention is not impaired. Examples of such components of the glass powder can include oxides composed of elements such as Al, Ga, Ge, Sn, P, Se, Te, and rare earth elements.

In addition, another feature of the glass powder in the present invention is that oxides of Pb and Cd are not used. Needless to say, this is because the toxicity and harmfulness of Pb and Cd are considered. But, in view of the object of the present invention, that is, providing a dielectric ceramic material that can be fired at low temperature and has high relative permittivity, there is no superiority in using oxides of Pb and Cd, and the superiority of the present invention lies in using the above-described glass powder.

The blending amount of the above-described glass powder is 1% by weight to 15% by weight, preferably 2% by weight to 10% by weight, with respect to the amount of the target dielectric ceramic-forming composition because when the blending amount of the glass powder is less than 1% by weight, sufficient sinterability is not obtained, and on the other hand, when the blending amount of the glass powder is more than 15% by weight, electrical characteristics degradation due to an excess of glass is significant.

In the present invention, in order to prepare the glass powder having the above-described composition, a mixture of two or more glass powders having different compositions may be used. For example, a mixture of a first glass powder containing Bi₂O₃ and ZnO as components and a second glass powder containing B₂O₃, SiO₂, an oxide of an alkali metal, and an oxide of an alkaline earth metal as components can be used.

A preferred embodiment of the mixture of the first glass powder containing Bi₂O₃ and ZnO as components and the second glass powder containing B₂O₃, SiO₂, an oxide of an alkali metal, and an oxide of an alkaline earth metal as components will be described in more detail.

The first glass powder contains Bi₂O₃ and ZnO as components, and in terms of less relative permittivity inhibition, the first glass powder comprises, on an oxide basis, preferably 70% by weight to 95% by weight, more preferably 75% by weight to 90% by weight, of Bi₂O₃ and preferably 2.5% by weight to 20% by weight, more preferably 5% by weight to 15% by weight, of ZnO.

The first glass powder may comprise an oxide of an alkali metal, an oxide of an alkaline earth metal, B₂O₃, TiO₂, carbon, CuO, and the like, as components other than Bi₂O₃ and ZnO. Particularly, the use of the first glass powder containing CuO is preferred because sintering can be performed even at a low temperature of about 700° C., and the relative permittivity of the obtained dielectric ceramic material is high.

The average particle diameter of the first glass powder is preferably 0.1 μm to 10 μm, more preferably 0.2 μm to 6.5 μm. The average particle diameter of the first glass powder in the range is preferred because homogeneous mixing with the dielectric powder, formability, and sinterability are improved. The average particle diameter of the first glass powder in the present invention is a value obtained from a particle diameter D50 in volume distribution measurement using a laser diffraction method.

In addition, the BET specific surface area of the first glass powder is preferably 0.2 m²/g to 20 m²/g, more preferably 0.2 m²/g to 15 m²/g. The BET specific surface area of the first glass powder in the range is preferred because homogeneous mixing with the dielectric powder, formability, and sinterability are improved.

In addition, in terms of improving sinterability from lower temperature, the glass transition temperature of the first glass powder is preferably 450° C. or lower, more preferably 300° C. to 400° C., and the glass softening temperature is preferably 500° C. or lower, more preferably 350° C. to 450° C.

The second glass powder contains B₂O₂, SiO₂, an oxide of an alkali metal, and an oxide of an alkaline earth metal as components, and in terms of better volume shrinkage properties during firing, the second glass powder comprises preferably 10% by weight to 30% by weight, more preferably 15% by weight to 27% by weight, of B₂O₂, preferably 5% by weight to 25% by weight, more preferably 10% by weight to 20% by weight, of SiO₂, preferably 10% by weight to 30% by weight, more preferably 15% by weight to 25% by weight, of one or more oxides of alkali metals selected from the group consisting of Li, Na, and K, and preferably 30% by weight to 50% by weight, more preferably 35% by weight to 45% by weight, of one or more oxides of alkaline earth metals selected from the group consisting of Mg, Ca, Sr, and Ba.

Particularly, the second glass powder preferably contains B₂O₂, SiO₂, Li₂O, BaO, and CaO as components, and more preferably contains 15% to 25% by weight of B₂O₃, 10% by weight to 20% by weight of SiO₂, 15% by weight to 25% by weight of Li₂O, 15% by weight to 25% by weight of BaO, and 15% by weight to 25% by weight of CaO, in terms of stable fabrication as a glass powder.

The second glass powder may comprise Al₂O₂ and the like as components other than B₂O₂, SiO₂, an oxide of an alkali metal, and an oxide of an alkaline earth metal.

The average particle diameter of the second glass powder is preferably 0.1 μm to 10 μm, more preferably 0.2 μm to 2 μm. The average particle diameter of the second glass powder in the range is preferred because homogeneous mixing with the dielectric powder, formability, and sinterability are improved. The average particle diameter of the second glass powder in the present invention is a value obtained from a particle diameter D50 in volume distribution measurement using a laser diffraction method.

In addition, the BET specific surface area of the second glass powder is preferably 1 m²/g to 50 m²/g, more preferably 2 m²/g to 20 m²/g. The BET specific surface area of the second glass powder in the range is preferred because homogeneous mixing with the dielectric powder, formability, and sinterability are improved.

In addition, in terms of improving sinterability from lower temperature, the glass transition temperature of the second glass powder is preferably 450° C. or lower, more preferably 300° C. to 400° C., and the glass softening temperature is preferably 500° C. or lower, more preferably 350° C. to 450° C.

The weight ratio of the first glass powder to the second glass powder is preferably in the range of 20:1 to 1:1, more preferably in the range of 10:1 to 1:1. When the amount of the second glass powder is too large, the degradation of electrical characteristics tends to be significant, and when the amount of the second glass powder is too small, sinterability tends to worsen extremely. Therefore, neither is preferred.

For the glass powders such as the first glass powder and the second glass powder as described above, commercial products can be used.

In addition, the dielectric ceramic-forming composition of the present invention can contain an accessory component element-containing compound powder containing at least one accessory component element selected from the group consisting of rare earth elements consisting of Sc, Y, La, Ce, Pr, Nd, Sm, Eu, Gd, Tb, Dy, Ho, Er, Tm, Yb, and Lu, Mg, Ca, Sr, Zr, Hf, V, Nb, Ta, Mn, Cr, Mo, and W, other than the perovskite (ABO₃)-type ceramic raw material powder and the glass powder, for the purpose of correcting electrical characteristics and temperature characteristics. Examples of the accessory component element-containing compound include oxides, hydroxides, carbonates, sulfates, nitrates, chlorides, carboxylates, ammonium salts, and organic acid salts comprising accessory component elements. One of these may be used alone, or two or more of these may be used in combination. Among these, Nd-containing compounds, such as Nd(OH)₃ and Nd₂O₃, Pr-containing compounds, such as Pr(OH)₃ and Pr₆O₁₁, La-containing compounds, such as La(OH)₃ and La₂O₃, Sm-containing compounds, such as Sm(OH)₃ and Sm₂O₃, Eu-containing compounds, such as Eu(OH)₃ and Eu₂O₃, and the like are preferred in terms of flattening temperature characteristics and reducing dielectric loss.

The average particle diameter of the accessory component element-containing compound powder is preferably 0.01 μm to 5 more preferably 0.02 μm to 3 μm. The average particle diameter of the accessory component element-containing compound powder in the range is preferred because the improvement of the homogeneous blending properties of the dielectric powder and the glass powder and sinterability improvement are promoted. The average particle diameter of the accessory component element-containing compound powder in the present invention is a value obtained from a particle diameter D50 in volume distribution measurement using a laser diffraction method.

In addition, the BET specific surface area of the accessory component element-containing compound powder is preferably 2 m²/g to 200 m²/g, more preferably 2 m²/g to 100 m²/g. The BET specific surface area of the accessory component element-containing compound powder in the range is preferred because the improvement of the homogeneous blending properties of the dielectric powder and the glass powder and sinterability improvement are promoted.

For the blending amount of the above-described accessory component element-containing compound powder, the accessory component element is preferably 0.1 mole % to 5 mole %, more preferably 1 mole % to 3 mole %, with respect to the amount in terms of moles of the perovskite (ABO₃)-type ceramic raw material powder used. The blending amount of the accessory component element-containing compound powder in the range is preferred because a sintering composition having a good balance between sinterability and electrical characteristics is obtained. In this case, the amount of the perovskite (ABO₃)-type ceramic raw material powder actually used is adjusted so that the sum of the amount of the perovskite (ABO₃)-type ceramic raw material powder actually used and the amount of the accessory component element-containing compound powder blended is 100 mole %.

The dielectric ceramic-forming composition of the present invention is prepared by mixing the perovskite (ABO₃)-type ceramic raw material powder, the glass powder, and the accessory component element-containing compound powder used as required in the desired blending proportion. The mixing method is not particularly limited and includes a wet method and a dry method.

For the wet method, publicly known apparatuses, such as a ball mill, a bead mill, Dispermill, a homogenizer, a vibration mill, a sand grind mill, an attritor, and a powerful stirrer, can be used. In addition, for the dry method, publicly known apparatuses, such as a high-speed mixer, a super mixer, Turbo Sphere Mixer, Henschel Mixer, Nauta Mixer, and a ribbon blender, can be used.

In terms of providing a more uniform mixture and obtaining a dielectric ceramic material having higher permittivity, the dielectric ceramic-forming composition of the present invention is preferably prepared by the wet method. Examples of a solvent used in wet mixing include water, methanol, ethanol, propanol, butanol, toluene, xylene, acetone, methylene chloride, ethyl acetate, dimethylformamide, and diethyl ether. When alcohols, such as methanol, ethanol, propanol, and butanol, are used among these, one with a small composition change is obtained, and therefore, the permittivity of the obtained dielectric ceramic material can be more improved.

The dielectric ceramic material of the present invention is obtained by firing the above-described dielectric ceramic-forming composition. The firing temperature is not particularly limited as long as it is a temperature at which the dielectric ceramic-forming composition can be sintered. Considering the advantages of the present invention, the firing temperature is 1000° C. or lower, preferably 650° C. to 970° C., and more preferably 700° C. to 950° C. The firing time is generally 1 hour or more, preferably 1 hour to 2 hours. The firing may be performed in any of an air atmosphere, an oxygen atmosphere, or an inert atmosphere and is not particularly limited. In addition, the firing may be performed a plurality of times as required.

The dielectric ceramic material of the present invention may be obtained by mixing the above-described dielectric ceramic-forming composition with a binder resin, granulating the mixture, and then pressing the granulated material using a hand press, a tableting machine, a briquetting machine, a roller compactor, or the like, and firing the formed article. In addition, the dielectric ceramic material of the present invention may be obtained by blending a resin, a solvent, and a plasticizer, a dispersing agent, and the like as required, which are publicly known in the art, into the above-described dielectric ceramic-forming composition to form a slurry (or paste), applying the slurry (or paste) to the desired substrate, and then drying and firing it.

As one example of this, for example, a preparation method using a green sheet method will be described. A resin, such as ethyl cellulose, polyvinyl butyral, an acrylic resin, or a methacrylic resin, a solvent, such as terpineol, diethylene glycol monobutyl ether acetate, ethylene glycol monomethyl ether, ethylene glycol monoethyl ether, ethylene glycol monobutyl ether, propylene glycol monoethyl ether, acetic acid-n-butyl, amyl acetate, ethyl lactate, lactic acid-n-butyl, methyl cellosolve acetate, ethyl cellosolve acetate, propylene glycol monomethyl ether acetate, ethyl-3-ethoxypropionate, 2,2,4-trimethyl-1,3-pentadiol monoisobutyrate, toluene, xylene, isopropyl alcohol, methanol, ethanol, butanol, n-pentanol, 4-methyl-2-pentanol, cyclohexanol, diacetone alcohol, diethyl ketone, methyl butyl ketone, dipropyl ketone, or hexanone, a plasticizer, such as dibutyl phthalate, dioctyl phthalate, butyl benzyl phthalate, or dicapryl phthalate, as required, and a dispersing agent, such as a surfactant, as required are added to the dielectric ceramic-forming composition of the present invention to form a slurry. This slurry is formed into a sheet shape on a substrate, such as a polyethylene terephthalate (PET) film, a polyethylene film, a polypropylene film, a polyester film, a polyimide film, aramid, Kapton, or polymethylpentene, by a method, such as a doctor blade method, and this is dried to remove the solvent to obtain a green sheet. By firing this green sheet at 1000° C. or lower, preferably 650° C. to 900° C., and more preferably 750° C. to 880° C., a thin plate-shaped dielectric ceramic material is obtained. The substrate is not limited to a plastic substrate and may be metal foil, a glass plate used for a plasma display panel, or the like.

Although sintering is performed at a low temperature of 1000° C. or lower, preferably 650° C. to 970° C., and more preferably 700° C. to 950° C., the dielectric ceramic material of the present invention has a high relative permittivity of preferably 500 or more, further preferably 900 or more, more preferably 1000 or more, and most preferably 2000 or more at a frequency of 1 kHz and has a low dielectric loss of preferably 5% or less, more preferably 3.5% or less, and most preferably 2.5% or less at a frequency of 1 kHz. Therefore, for example, the dielectric ceramic material of the present invention can not only be used as dielectric materials for thin-layer ceramic capacitors, but can also be preferably used as dielectric materials for electronic components, such as printed wiring boards, multilayer printed wiring boards, electrode ceramic circuit boards, glass ceramic circuit boards, circuit peripheral materials, inorganic ELs, and plasma displays.

### EXAMPLES

The present invention will be described below in detail by Examples, but the present invention is not limited to these.

### <Perovskite (ABO₃)-Type Ceramic Raw Material Powder Samples>

Commercial barium titanates having physical properties shown in Table 1, which were prepared by an oxalate method, were used as a perovskite (ABO₃)-type ceramic raw material powder.

TABLE 1

| | | BET |
|---|---|---|
| Ceramic raw | Average | specific |
| material | particle | surface |
| powder | diameter | area |
| sample | (μm) | (m²/g) |
| A | 0.69 | 2.00 |
| B | 0.57 | 2.67 |
| C | 0.53 | 3.58 |
| D | 0.47 | 4.29 |

### <Glass Powder Samples>

Commercial glass powders having physical properties shown in Table 2 and Table 3 were used as a first glass powder and a second glass powder. In addition, the composition of mixtures of the first glass powder and the second glass powder mixed at predetermined weight ratios is shown in Table 4.

TABLE 2

| | | First glass powder sample | | | |
|---|---|---|---|---|---|
| | | a1 | b1 | c1 | d1 |
| Composition | Bi₂O₃ | 84.9 | 84.6 | 88.3 | 82.7 |
| (% by | ZnO | 10.8 | 8.8 | 11.1 | 7.8 |
| weight) | B₂O₃ | 3.9 | — | — | 3.9 |
| | BaO | 0.4 | 4.4 | — | 3.7 |
| | CuO | — | 2.2 | 0.6 | 1.9 |
| Physical | Average | 0.9 | 5.3 | 1.1 | 0.6 |
| properties | particle | | | | |
| | diameter (μm) | | | | |
| | BET specific | 1.87 | 0.31 | 1.51 | 2.96 |
| | surface area | | | | |
| | (m²/g) | | | | |

TABLE 3

| | | Second glass powder sample | | | | |
|---|---|---|---|---|---|---|
| | | a2 | b2 | c2 | d2 | e2 |
| Composition | SiO₂ | 19 | 16.2 | 18.1 | 16 | 16 |
| (% by | B₂O₃ | 19.1 | 24.4 | 24.9 | 22 | 21 |
| weight)) | BaO | 25.3 | 19.9 | 22.7 | 20 | 21 |
| | CaO | 21.8 | 18.4 | 21.5 | 20 | 21 |
| | Li₂O | 14.8 | 21.1 | 12.8 | 22 | 21 |
| Physical | Average | 1.8 | 2.1 | 1.5 | 1.0 | 1.0 |
| properties | particle | | | | | |
| | diameter(μm) | | | | | |
| | BET specific | 2.47 | 2.95 | 3.81 | 5.75 | 8.5 |
| | surface area | | | | | |
| | (m²/g) | | | | | |

TABLE 4

| Mixture of first glass | | | | | | | | | |
|---|---|---|---|---|---|---|---|---|---|
| powder + second glass | | Composition (% by weight) | | | | | | | |
| powder (weight ratio) | | Bi₂O₃ | ZnO | B₂O₃ | SiO₂ | Li₂O | BaO | CaO | CuO |
| m1 | a1:a2 = 9:1 | 76.4 | 9.7 | 5.4 | 1.9 | 1.5 | 2.9 | 2.2 | 0 |
| m2 | a1:a2 = 4:1 | 67.9 | 8.6 | 6.9 | 3.8 | 3.0 | 5.4 | 4.4 | 0 |
| m3 | a1:a2 = 7:3 | 59.4 | 7.6 | 8.5 | 5.7 | 4.4 | 7.9 | 6.5 | 0 |
| m4 | a1:a2 = 3:2 | 50.9 | 6.5 | 10.0 | 7.6 | 5.9 | 10.4 | 8.7 | 0 |
| m5 | a1:a2 = 1:1 | 42.5 | 5.4 | 11.5 | 9.5 | 7.4 | 12.9 | 10.9 | 0 |
| m6 | a1:b2 = 9:1 | 76.4 | 9.7 | 6.0 | 1.6 | 2.1 | 2.4 | 1.8 | 0 |
| m7 | a1:b2 = 4:1 | 67.9 | 8.6 | 8.0 | 3.2 | 4.2 | 4.3 | 3.7 | 0 |
| m8 | a1:b2 = 7:3 | 59.4 | 7.6 | 10.1 | 4.9 | 6.3 | 6.3 | 5.5 | 0 |
| m9 | a1:b2 = 3:2 | 50.9 | 6.5 | 12.1 | 6.5 | 8.4 | 8.2 | 7.4 | 0 |
| m10 | a1:b2 = 1:1 | 42.5 | 5.4 | 14.2 | 8.1 | 10.6 | 10.2 | 9.2 | 0 |
| m11 | a1:c2 = 7:3 | 59.4 | 7.6 | 10.2 | 5.4 | 3.8 | 7.1 | 6.5 | 0 |
| m12 | a1:d2 = 7:3 | 59.4 | 7.6 | 9.3 | 4.8 | 6.6 | 6.3 | 6.0 | 0 |
| m13 | b1:b2 = 7:3 | 59.2 | 6.2 | 7.3 | 4.9 | 6.3 | 9.1 | 5.5 | 1.5 |
| m14 | b1:d2 = 7:3 | 59.2 | 6.2 | 6.6 | 4.8 | 6.6 | 9.1 | 6.0 | 1.5 |
| m15 | c1:b2 = 7:3 | 61.8 | 7.8 | 7.3 | 4.9 | 6.3 | 6.0 | 5.5 | 0.4 |
| m16 | c1:d2 = 7:3 | 61.8 | 7.8 | 6.6 | 4.8 | 6.6 | 6.0 | 6.0 | 0.4 |
| m17 | d1:b2 = 7:3 | 57.9 | 5.5 | 10.1 | 4.9 | 6.3 | 8.6 | 5.5 | 1.3 |
| m18 | d1:d2 = 7:3 | 57.9 | 5.5 | 9.3 | 4.8 | 6.6 | 8.6 | 6.0 | 1.3 |
| m19 | a1:b2 = 31:9 | 65.8 | 8.4 | 8.5 | 3.6 | 4.8 | 4.8 | 4.1 | 0 |
| m20 | a1:b2 = 3:1 | 63.7 | 8.1 | 9.0 | 4.1 | 5.3 | 5.3 | 4.6 | 0 |
| m21 | a1:b2 = 29:11 | 61.6 | 7.8 | 9.5 | 4.5 | 5.8 | 5.8 | 5.1 | 0 |
| m22 | a1:e2 = 7:3 | 59.4 | 7.6 | 9.0 | 4.8 | 6.3 | 6.6 | 6.3 | 0 |
| m23 | c1:e2 = 7:3 | 61.8 | 7.7 | 6.3 | 4.8 | 6.3 | 6.3 | 6.3 | 0.5 |

### <Accessory Component Element-Containing Compound Samples)

Commercial compounds having physical properties shown in Table 5 were used as an accessory component element-containing compound.

TABLE 5

| | | |
|---|---|---|
| Accessory | | BET |
| component | Average | specific |
| element- | particle | surface |
| containing | diameter | area |
| compound | (μm) | (m²/g) |

| | | | |
|---|---|---|---|
| a3 | Nd(OH)₃ | 1.0 | 25.79 |
| b3 | Nd₂O₃ | 0.6 | 14.15 |
| c3 | La₂O₃ | 1.1 | 12.33 |
| d3 | Pr₆O₁₁ | 0.4 | 12.91 |
| e3 | MnO₂ | 2.7 | 36.67 |

### Examples 1 to 21 and Comparative Examples 1 to 4

A nylon pot having a volume of 700 ml was charged with 1150 g of ZrO₂ balls (diameter 5 mm), and a total of 60 g of a ceramic raw material powder and a glass powder in a blending proportion shown in Table 6, and then charged with 95 g of ethanol. A pot mill was operated at 80 rpm for 2 hours to obtain a slurry. Then, the ZrO₂ balls were separated from the slurry, and then, the total amount of the slurry was dried to obtain a dielectric ceramic-forming sample.

10 g of the obtained dielectric ceramic-forming sample was weighed, and 1.3 g of a 5% by weight solution of a polyvinyl acetal resin (a mixed solvent with toluene:n-butanol=6:4) was added. They were sufficiently mixed in a mortar to obtain a granulated material. The obtained granulated material was strained through a nylon sieve having a mesh size of 150 μm, and then dried at 80° C. for 1 hour to obtain a dried product.

Then, the obtained dried product was subjected to uniaxial pressing at a pressure of 470 MPa using an 11.5 mm φ cemented carbide die to obtain a disk-shaped formed body.

Finally, the obtained disk-shaped formed body was heated in an air atmosphere to firing temperature shown in Table 6 at a rate of 200° per hour, maintained as it was for 2 hours, and then cooled to obtain a dielectric ceramic sample.

TABLE 6

| | Type of | Glass powder | | |
|---|---|---|---|---|
| | ceramic | | Blending | |
| | raw | | amount*⁾ | Firing |
| | material | | (% by | Temperature |
| | powder | Type | weight) | (° C.) |
| Example 1 | A | m1 | 9 | 650 |
| Example 2 | A | m2 | 9 | 650 |
| Example 3 | A | m3 | 9 | 650 |
| Example 4 | A | m4 | 9 | 650 |
| Example 5 | A | m5 | 9 | 650 |
| Example 6 | A | m3 | 10 | 650 |
| Example 7 | A | m3 | 8 | 650 |
| Example 8 | A | m3 | 7 | 650 |
| Example 9 | A | m3 | 6 | 650 |
| Example 10 | A | m3 | 5 | 650 |
| Example 11 | A | m1 | 9 | 700 |
| Example 12 | A | m2 | 9 | 700 |
| Example 13 | A | m3 | 9 | 700 |
| Example 14 | A | m4 | 9 | 700 |
| Example 15 | A | m5 | 9 | 700 |
| Example 16 | A | m3 | 10 | 700 |
| Example 17 | A | m3 | 8 | 700 |
| Example 18 | A | m3 | 7 | 700 |
| Example 19 | A | m3 | 6 | 700 |
| Example 20 | A | m3 | 5 | 700 |
| Example 21 | A | m3 | 9 | 750 |
| Comparative | A | a1 | 9 | 650 |
| Example 1 | | | | |
| Comparative | A | a1 | 9 | 700 |
| Example 2 | | | | |
| Comparative | A | a2 | 9 | 650 |
| Example 3 | | | | |
| Comparative | A | a2 | 9 | 700 |
| Example 4 | | | | |

*⁾The blending amount of the glass powder is an amount (% by weight) with respect to the amount of the target dielectric ceramic-forming composition.

### <Characteristics Evaluation>

For the obtained dielectric ceramic samples, sintered density, volume shrinkage rate, relative permittivity, and dielectric loss were evaluated. The evaluation results are shown in Table 7.

### (1) Evaluation of Sintered Density

The weight, thickness, and diameter of the dielectric ceramic sample were measured, and sintered density was obtained from these values.

### (2) Evaluation of Volume Shrinkage Rate

From volume before firing, which was obtained by measuring the thickness and diameter of the disk-shaped formed body, and volume after firing, which was obtained by measuring the thickness and diameter of the dielectric ceramic sample, volume shrinkage rate (%)=(volume before firing−volume after firing)/volume before firing×100 was obtained.

### (3) Evaluation of Electrical Characteristics (Relative Permittivity and Dielectric Loss)

A platinum film having a thickness of 20 nm, as an electrode, was formed on both surfaces of the dielectric ceramic sample by a vapor deposition method, and then, relative permittivity and dielectric loss at a frequency of 1 kHz and an applied voltage of 1 V were measured by an LCR meter (4284A manufactured by Agilent Technologies). In addition, when temperature characteristics were evaluated, relative permittivity and dielectric loss were measured at 5° C. intervals in the range of −55° C. to 150° C. using a thermostat, and using relative permittivity at reference temperature (25° C.) as a reference value, the proportion of change (the rate of change) in relative permittivity at each measurement temperature was obtained by the following formula.

the proportion of change (the rate of change) in relative permittivity at measurement temperature=[(relative permittivity at measurement temperature)−(relative permittivity at reference temperature)]/(relative permittivity at reference temperature)×100

From the obtained rate of change, temperature characteristics were evaluated according to the following standard.

X7R: all rates of change are within the range of −15% to 15% in the temperature range of −55° C. to 125° C.
X8R: all rates of change are within the range of −15% to 15% in the temperature range of −55° C. to 150° C.

TABLE 7

| | Sintered | Volume | Relative | |
|---|---|---|---|---|
| | density | shrinkage | permittivity | Dielectric |
| | (g/cm³) | rate (%) | (—) | loss (%) |
| Example 1 | 4.04 | 2.64 | 509 | 0.87 |
| Example 2 | 4.06 | 3.72 | 567 | 0.99 |
| Example 3 | 4.07 | 5.39 | 707 | 1.08 |
| Example 4 | 4.06 | 6.19 | 738 | 1.00 |
| Example 5 | 3.98 | 5.64 | 750 | 0.92 |
| Example 6 | 4.07 | 5.88 | 707 | 1.07 |
| Example 7 | 4.06 | 5.70 | 723 | 0.97 |
| Example 8 | 4.08 | 5.88 | 770 | 0.97 |
| Example 9 | 4.06 | 4.74 | 751 | 0.94 |
| Example 10 | 4.02 | 4.14 | 677 | 1.19 |
| Example 11 | 4.36 | 9.88 | 1057 | 1.09 |
| Example 12 | 4.37 | 10.99 | 1145 | 1.18 |
| Example 13 | 4.36 | 11.46 | 1186 | 1.06 |
| Example 14 | 4.34 | 12.23 | 1118 | 1.00 |
| Example 15 | 4.25 | 11.62 | 1028 | 0.90 |
| Example 16 | 4.38 | 12.52 | 1072 | 1.09 |
| Example 17 | 4.37 | 12.01 | 1175 | 1.10 |
| Example 18 | 4.38 | 12.14 | 1160 | 1.13 |
| Example 19 | 4.29 | 9.99 | 1137 | 1.08 |
| Example 20 | 4.18 | 8.02 | 989 | 1.06 |
| Example 21 | 4.85 | 20.8 | 1674 | 1.16 |
| Comparative | 4.11 | 3.40 | 477 | 0.86 |
| Example 1 | | | | |
| Comparative | 4.25 | 6.76 | 826 | 1.01 |
| Example 2 | | | | |
| Comparative | 3.66 | −0.22 | 351 | 0.66 |
| Example 3 | | | | |
| Comparative | 3.75 | 5.48 | 531 | 0.66 |
| Example 4 | | | | |

### Examples 22 to 49 and Comparative Examples 5 to 6

A nylon pot having a volume of 700 ml was charged with 1150 g of ZrO₂ balls (diameter 5 mm), and a total of 60 g of a ceramic raw material powder and a glass powder in a blending proportion shown in Table 8, and then charged with 95 g of ethanol. A pot mill was operated at 80 rpm for 2 hours to obtain a slurry. Then, the ZrO₂ balls were separated from the slurry, and then, the total amount of the slurry was dried to obtain a dielectric ceramic-forming sample.

10 g of the obtained dielectric ceramic-forming sample was weighed, and 1.3 g of a 5% by weight solution of a polyvinyl acetal resin (a mixed solvent with toluene:n-butanol=6:4) was added. They were sufficiently mixed in a mortar to obtain a granulated material. The obtained granulated material was strained through a nylon sieve having a mesh size of 150 μm, and then dried at 80° C. for 1 hour to obtain a dried product.

Then, the obtained dried product was subjected to uniaxial pressing at a pressure of 470 MPa using an 11.5 mm φ cemented carbide die to obtain a disk-shaped formed body.

Finally, the obtained disk-shaped formed body was heated in an air atmosphere to firing temperature shown in Table 8 at a rate of 200° per hour, maintained as it was for 2 hours, and then cooled to obtain a dielectric ceramic sample.

TABLE 8

| | Type of | Glass powder | | |
|---|---|---|---|---|
| | ceramic | | Blending | |
| | raw | | amount*⁾ | Firing |
| | material | | (% by | temperature |
| | powder | Type | weight) | (° C.) |
| Example 22 | A | m6 | 9 | 650 |
| Example 23 | A | m7 | 9 | 650 |
| Example 24 | A | m8 | 9 | 650 |
| Example 25 | A | m9 | 9 | 650 |
| Example 26 | A | m10 | 9 | 650 |
| Example 27 | A | m8 | 10 | 650 |
| Example 28 | A | m8 | 8 | 650 |
| Example 29 | A | m8 | 7 | 650 |
| Example 30 | A | m8 | 6 | 650 |
| Example 31 | A | m8 | 5 | 650 |
| Example 32 | A | m6 | 9 | 700 |
| Example 33 | A | m7 | 9 | 700 |
| Example 34 | A | m8 | 9 | 700 |
| Example 35 | A | m9 | 9 | 700 |
| Example 36 | A | m10 | 9 | 700 |
| Example 37 | A | m8 | 10 | 700 |
| Example 38 | A | m8 | 8 | 700 |
| Example 39 | A | m8 | 7 | 700 |
| Example 40 | A | m8 | 6 | 700 |
| Example 41 | A | m8 | 5 | 700 |
| Example 42 | A | m8 | 8 | 750 |
| Example 43 | A | m8 | 8 | 800 |
| Example 44 | A | m11 | 9 | 650 |
| Example 45 | A | m11 | 9 | 700 |
| Example 46 | A | m11 | 9 | 750 |
| Example 47 | A | m12 | 9 | 650 |
| Example 48 | A | m12 | 9 | 700 |
| Example 49 | A | m12 | 9 | 750 |
| Comparative | A | b2 | 9 | 650 |
| Example 5 | | | | |
| Comparative | A | b2 | 9 | 700 |
| Example 6 | | | | |

*⁾The blending amount of the glass powder is an amount (% by weight) with respect to the amount of the target dielectric ceramic-forming composition.

### <Characteristics Evaluation>

For the obtained dielectric ceramic samples, sintered density, volume shrinkage rate, relative permittivity, and dielectric loss were obtained as in Examples 1 to 21. The results are shown in Table 9.

TABLE 9

| | Sintered | Volume | Relative | |
|---|---|---|---|---|
| | density | shrinkage | permittivity | Dielectric |
| | (g/cm³) | rate (%) | (—) | loss (%) |
| Example 22 | 4.06 | 2.63 | 526 | 0.87 |
| Example 23 | 4.12 | 5.88 | 706 | 0.92 |
| Example 24 | 4.16 | 7.62 | 919 | 0.98 |
| Example 25 | 4.12 | 7.86 | 765 | 0.85 |
| Example 26 | 4.01 | 6.84 | 599 | 0.80 |
| Example 27 | 4.15 | 7.43 | 747 | 0.92 |
| Example 28 | 4.18 | 7.77 | 928 | 1.11 |
| Example 29 | 4.19 | 7.62 | 973 | 0.93 |
| Example 30 | 4.15 | 6.87 | 970 | 1.03 |
| Example 31 | 4.1 | 5.51 | 908 | 1.01 |
| Example 32 | 4.35 | 9.41 | 1019 | 1.09 |
| Example 33 | 4.45 | 12.41 | 1245 | 1.05 |
| Example 34 | 4.52 | 15.07 | 1367 | 1.14 |
| Example 35 | 4.51 | 16.27 | 1323 | 0.99 |
| Example 36 | 4.38 | 14.47 | 1077 | 1.00 |
| Example 37 | 4.5 | 14.50 | 1322 | 1.10 |
| Example 38 | 4.56 | 15.60 | 1448 | 1.20 |
| Example 39 | 4.5 | 14.22 | 1374 | 1.08 |
| Example 40 | 4.38 | 11.86 | 1265 | 1.13 |
| Example 41 | 4.3 | 9.99 | 1277 | 1.08 |
| Example 42 | 5.03 | 22.65 | 2044 | 1.21 |
| Example 43 | 5.49 | 29.14 | 2527 | 1.35 |
| Example 44 | 4.07 | 4.51 | 616 | 0.87 |
| Example 45 | 4.26 | 8.64 | 902 | 0.98 |
| Example 46 | 4.51 | 13.80 | 1355 | 1.15 |
| Example 47 | 4.16 | 7.20 | 758 | 1.04 |
| Example 48 | 4.56 | 15.58 | 1508 | 0.94 |
| Example 49 | 4.95 | 22.00 | 1809 | 1.11 |
| Comparative | 3.72 | −0.11 | 376 | 0.65 |
| Example 5 | | | | |
| Comparative | 3.84 | 5.40 | 551 | 0.68 |
| Example 6 | | | | |

### Examples 50 to 87

A nylon pot having a volume of 700 ml was charged with 1150 g of ZrO₂ balls (diameter 5 mm), and a total of 60 g of a ceramic raw material powder and a glass powder in a blending proportion shown in Table 10, and then charged with 95 g of ethanol. A pot mill was operated at 80 rpm for 2 hours to obtain a slurry. Then, the ZrO₂ balls were separated from the slurry, and then, the total amount of the slurry was dried to obtain a dielectric ceramic-forming sample.

10 g of the obtained dielectric ceramic-forming sample was weighed, and 1.3 g of a 5% by weight solution of a polyvinyl acetal resin (a mixed solvent with toluene:n-butanol=6:4) was added. They were sufficiently mixed in a mortar to obtain a granulated material. The obtained granulated material was strained through a nylon sieve having a mesh size of 150 μm, and then dried at 80° C. for 1 hour to obtain a dried product.

Then, the obtained dried product was subjected to uniaxial pressing at a pressure of 470 MPa using an 11.5 mm φ cemented carbide die to obtain a disk-shaped formed body.

Finally, the obtained disk-shaped formed body was heated in an air atmosphere to firing temperature shown in Table 10 at a rate of 200° per hour, maintained as it was for 2 hours, and then cooled to obtain a dielectric ceramic sample.

TABLE 10

| | | Glass powder | | |
|---|---|---|---|---|
| | Type of | | Blending | |
| | ceramic raw | | amount*⁾ | Firing |
| | material | | (% by | temperature |
| | powder | Type | weight) | (° C.) |
| Example 50 | B | m4 | 9 | 650 |
| Example 51 | B | m8 | 8 | 650 |
| Example 52 | B | m12 | 8 | 650 |
| Example 53 | B | m13 | 8 | 650 |
| Example 54 | B | m14 | 8 | 650 |
| Example 55 | B | m15 | 8 | 650 |
| Example 56 | B | m16 | 8 | 650 |
| Example 57 | B | m17 | 8 | 650 |
| Example 58 | B | m18 | 8 | 650 |
| Example 59 | B | m23 | 8 | 650 |
| Example 60 | B | m9 | 9 | 700 |
| Example 61 | B | m8 | 8 | 700 |
| Example 62 | B | m12 | 8 | 700 |
| Example 63 | B | m13 | 8 | 700 |
| Example 64 | B | m14 | 8 | 700 |
| Example 65 | B | m15 | 8 | 700 |
| Example 66 | B | m16 | 8 | 700 |
| Example 67 | B | m17 | 8 | 700 |
| Example 68 | B | m18 | 8 | 700 |
| Example 69 | B | m23 | 8 | 700 |
| Example 70 | B | m8 | 8 | 750 |
| Example 71 | B | m12 | 8 | 750 |
| Example 72 | B | m13 | 8 | 750 |
| Example 73 | B | m14 | 8 | 750 |
| Example 74 | B | m15 | 8 | 750 |
| Example 75 | B | m16 | 8 | 750 |
| Example 76 | B | m17 | 8 | 750 |
| Example 77 | B | m18 | 8 | 750 |
| Example 78 | B | m23 | 8 | 750 |
| Example 79 | B | m8 | 8 | 800 |
| Example 80 | B | m12 | 8 | 800 |
| Example 81 | B | m13 | 8 | 800 |
| Example 82 | B | m14 | 8 | 800 |
| Example 83 | B | m15 | 8 | 800 |
| Example 84 | B | m16 | 8 | 800 |
| Example 85 | B | m17 | 8 | 800 |
| Example 86 | B | m18 | 8 | 800 |
| Example 87 | B | m23 | 8 | 800 |

*⁾The blending amount of the glass powder is an amount (% by weight) with respect to the amount of the target dielectric ceramic-forming composition.

### <Characteristics Evaluation>

For the obtained dielectric ceramic samples, sintered density, volume shrinkage rate, relative permittivity, and dielectric loss were obtained as in Examples 1 to 21. The results are shown in Table 11.

TABLE 11

| | Sintered | Volume | Relative | Dielectric |
|---|---|---|---|---|
| | density | shrinkage | permittivity | loss |
| | (g/cm³) | rate (%) | (—) | (%) |
| Example 50 | 4.15 | 7.26 | 778 | 0.76 |
| Example 51 | 4.26 | 9.83 | 981 | 0.80 |
| Example 52 | 4.23 | 9.83 | 913 | 0.76 |
| Example 53 | 4.31 | 11.42 | 1043 | 0.79 |
| Example 54 | 4.24 | 9.85 | 900 | 0.69 |
| Example 55 | 4.36 | 12.28 | 1084 | 0.79 |
| Example 56 | 4.24 | 9.93 | 947 | 0.67 |
| Example 57 | 4.30 | 11.59 | 1043 | 0.80 |
| Example 58 | 4.23 | 9.87 | 876 | 0.74 |
| Example 59 | 4.29 | 10.80 | 1047 | 0.79 |
| Example 60 | 4.54 | 15.10 | 1311 | 0.89 |
| Example 61 | 4.72 | 18.79 | 1502 | 0.90 |
| Example 62 | 4.68 | 18.61 | 1626 | 1.05 |
| Example 63 | 4.76 | 19.83 | 1488 | 0.95 |
| Example 64 | 4.70 | 18.72 | 1602 | 0.91 |
| Example 65 | 4.76 | 19.82 | 1509 | 0.96 |
| Example 66 | 4.71 | 18.91 | 1632 | 0.92 |
| Example 67 | 4.76 | 20.05 | 1525 | 0.91 |
| Example 68 | 4.70 | 18.82 | 1612 | 0.84 |
| Example 69 | 4.71 | 18.87 | 1795 | 0.93 |
| Example 70 | 5.25 | 27.10 | 2115 | 1.19 |
| Example 71 | 5.11 | 25.41 | 2123 | 1.23 |
| Example 72 | 5.85 | 27.85 | 2076 | 1.20 |
| Example 73 | 5.16 | 26.16 | 2228 | 1.17 |
| Example 74 | 5.25 | 27.39 | 2030 | 1.17 |
| Example 75 | 5.10 | 25.26 | 2459 | 1.17 |
| Example 76 | 5.30 | 28.21 | 2104 | 1.18 |
| Example 77 | 5.17 | 26.35 | 2004 | 0.97 |
| Example 78 | 5.11 | 25.19 | 2491 | 1.19 |
| Example 79 | 5.52 | 30.75 | 2293 | 1.35 |
| Example 80 | 5.43 | 29.66 | 2278 | 1.27 |
| Example 81 | 5.52 | 31.02 | 2232 | 1.32 |
| Example 82 | 5.45 | 30.15 | 2380 | 1.28 |
| Example 83 | 5.50 | 30.78 | 2212 | 1.30 |
| Example 84 | 5.43 | 29.69 | 2677 | 1.32 |
| Example 85 | 5.58 | 31.89 | 2309 | 1.33 |
| Example 86 | 5.52 | 30.91 | 2235 | 1.06 |
| Example 87 | 5.43 | 29.64 | 2796 | 1.41 |

### Examples 88 to 94

A nylon pot having a volume of 700 ml was charged with 1150 g of ZrO₂ balls (diameter 5 mm), and a total of 60 g of a ceramic raw material powder and a glass powder in a blending proportion shown in Table 12, and then charged with 95 g of ethanol. A pot mill was operated at 80 rpm for 2 hours to obtain a slurry. Then, the ZrO₂ balls were separated from the slurry, and then, the total amount of the slurry was dried to obtain a dielectric ceramic-forming sample.

10 g of the obtained dielectric ceramic-forming sample was weighed, and 1.3 g of a 5% by weight solution of a polyvinyl acetal resin (a mixed solvent with toluene:n-butanol=6:4) was added. They were sufficiently mixed in a mortar to obtain a granulated material. The obtained granulated material was strained through a nylon sieve having a mesh size of 150 μm, and then dried at 80° C. for 1 hour to obtain a dried product.

Then, the obtained dried product was subjected to uniaxial pressing at a pressure of 470 MPa using an 11.5 mm φ cemented carbide die to obtain a disk-shaped formed body.

Finally, the obtained disk-shaped formed body was heated in an air atmosphere to firing temperature shown in Table 12 at a rate of 200° per hour, maintained as it was for 2 hours, and then cooled to obtain a dielectric ceramic sample.

TABLE 12

| | Type of | Glass powder | | |
|---|---|---|---|---|
| | ceramic | | Blending | |
| | raw | | amount*⁾ | Firing |
| | material | | (% by | temperature |
| | powder | Type | weight) | (° C.) |
| Example 88 | C | m4 | 9 | 650 |
| Example 89 | C | m8 | 8 | 650 |
| Example 90 | D | m4 | 9 | 650 |
| Example 91 | C | m9 | 9 | 700 |
| Example 92 | C | m8 | 8 | 700 |
| Example 93 | D | m9 | 8 | 700 |
| Example 94 | C | m8 | 8 | 800 |

*⁾The blending amount of the glass powder is an amount (% by weight) with respect to the amount of the target dielectric ceramic-forming composition.

### <Characteristics Evaluation>

For the obtained dielectric ceramic samples, sintered density, volume shrinkage rate, relative permittivity, and dielectric loss were obtained as in Examples 1 to 21. The results are shown in Table 13.

TABLE 13

| | Sintered | Volume | Relative | |
|---|---|---|---|---|
| | density | shrinkage | permittivity | Dielectric |
| | (g/cm³) | rate (%) | (—) | loss (%) |
| Example 88 | 4.04 | 9.57 | 729 | 0.81 |
| Example 89 | 4.33 | 13.77 | 990 | 0.92 |
| Example 90 | 4.13 | 11.13 | 770 | 0.84 |
| Example 91 | 4.57 | 20.01 | 1234 | 1.08 |
| Example 92 | 4.88 | 23.83 | 1461 | 1.02 |
| Example 93 | 4.67 | 21.67 | 1130 | 0.92 |
| Example 94 | 5.54 | 32.36 | 1829 | 1.45 |

### Examples 95 to 121

A nylon pot having a volume of 700 ml was charged with 1150 g of ZrO₂ balls (diameter 5 mm), and a total of 60 g of a ceramic raw material powder, a glass powder, and an accessory component element-containing compound (Nd(OH)₃) powder in a blending proportion shown in Table 14, and then charged with 95 g of ethanol. A pot mill was operated at 80 rpm for 2 hours to obtain a slurry. Then, the ZrO₂ balls were separated from the slurry, and then, the total amount of the slurry was dried to obtain a dielectric ceramic-forming sample.

10 g of the obtained dielectric ceramic-forming sample was weighed, and 1.3 g of a 5% by weight solution of a polyvinyl acetal resin (a mixed solvent with toluene:n-butanol=6:4) was added. They were sufficiently mixed in a mortar to obtain a granulated material. The obtained granulated material was strained through a nylon sieve having a mesh size of 150 μm, and then dried at 80° C. for 1 hour to obtain a dried product.

Then, the obtained dried product was subjected to uniaxial pressing at a pressure of 470 MPa using an 11.5 mm φ cemented carbide die to obtain a disk-shaped formed body.

Finally, the obtained disk-shaped formed body was heated in an air atmosphere to firing temperature shown in Table 14 at a rate of 200° per hour, maintained as it was for 2 hours, and then cooled to obtain a dielectric ceramic sample.

TABLE 14

| | Accessory com- | | | | | |
|---|---|---|---|---|---|---|
| | ponent element- | | | | | |
| | containing | | Type of | Glass powder | | |
| | compound powder | | ceramic | | Blending | Firing |
| | | Blending | raw | | amount *²⁾ | tem- |
| | | amount *¹⁾ | material | | (% by | pera- |
| | Type | (mole %) | powder | Type | weight) | ture |
| Example95 | a3 | 1.0 | B | m9 | 8 | 700 |
| Example96 | a3 | 1.1 | B | m9 | 8 | 700 |
| Example97 | a3 | 1.2 | B | m9 | 8 | 700 |
| Example98 | a3 | 1.3 | B | m9 | 8 | 750 |
| Example99 | a3 | 1.4 | B | m9 | 8 | 750 |
| Example100 | a3 | 1.5 | B | m9 | 8 | 750 |
| Example101 | a3 | 1.5 | B | m9 | 8 | 800 |
| Example102 | a3 | 1.6 | B | m9 | 8 | 800 |
| Example103 | a3 | 1.9 | B | m9 | 8 | 800 |
| Example104 | a3 | 2.1 | A | m9 | 8 | 850 |
| Example105 | a3 | 2.4 | A | m8 | 8 | 850 |
| Example106 | a3 | 2.4 | A | m8 | 7 | 850 |
| Example107 | a3 | 2.4 | A | m8 | 6 | 850 |
| Example108 | a3 | 2.4 | A | m8 | 5 | 850 |
| Example109 | a3 | 2.4 | A | m8 | 4 | 850 |
| Example110 | a3 | 2.4 | A | m8 | 3 | 850 |
| Example111 | a3 | 2.4 | A | m8 | 2 | 850 |
| Example112 | a3 | 2.2 | A | m8 | 8 | 900 |
| Example113 | a3 | 2.3 | A | m8 | 8 | 900 |
| Example114 | a3 | 2.4 | A | m8 | 8 | 900 |
| Example115 | a3 | 2.0 | A | m6 | 3 | 850 |
| Example116 | a3 | 2.0 | A | m7 | 3 | 850 |
| Example117 | a3 | 2.1 | A | m19 | 3 | 850 |
| Example118 | a3 | 2.2 | A | m20 | 3 | 850 |
| Example119 | a3 | 2.3 | A | m21 | 3 | 850 |
| Example120 | a3 | 2.4 | A | m8 | 3 | 850 |
| Example121 | a3 | 2.0 | A | m8 | 3 | 850 |

*¹⁾ The blending amount of the accessory component element-containing compound powder is the amount (mole %) of the accessory component element with respect to the amount in terms of moles of the ceramic raw material powder.
*²⁾ The blending amount of the glass powder is an amount (% by weight) with respect to the amount of the target dielectric ceramic-forming composition.

### <Characteristics Evaluation>

For the obtained dielectric ceramic samples, sintered density, volume shrinkage rate, relative permittivity, dielectric loss, and temperature characteristics were obtained as in Examples 1 to 21. The results are shown in Table 15.

TABLE 15

| | | | Relative | | | |
|---|---|---|---|---|---|---|
| | | Volume | permit- | Dielectric | | Temper- |
| | Sintered | shrinkage | tivity | loss | | ature |
| | density | rate | 25° C. | 25° C. | MAX | character- |
| | (g/cm³) | (%) | (—) | (%) | (%) | istics |
| Example95 | 4.51 | 16.54 | 1138 | 0.67 | 1.72 | X8R |
| Example96 | 4.45 | 15.46 | 1071 | 0.67 | 1.60 | X8R |
| Example97 | 4.37 | 13.64 | 980 | 0.61 | 1.50 | X8R |
| Example98 | 4.89 | 23.10 | 1424 | 0.62 | 1.61 | X8R |
| Example99 | 4.65 | 19.00 | 1257 | 0.63 | 1.53 | X8R |
| Example100 | 4.49 | 15.05 | 1112 | 0.68 | 1.57 | X8R |
| Example101 | 5.62 | 32.81 | 1999 | 0.79 | 2.11 | X8R |
| Example102 | 5.63 | 33.22 | 1984 | 0.67 | 1.96 | X8R |
| Example103 | 5.56 | 32.69 | 2016 | 0.70 | 1.85 | X8R |
| Example104 | 5.72 | 32.82 | 2042 | 0.73 | 2.61 | X7R |
| Example105 | 5.73 | 32.74 | 2183 | 0.74 | 2.50 | X7R |
| Example106 | 5.75 | 32.25 | 2351 | 0.79 | 2.41 | X7R |
| Example107 | 5.74 | 32.24 | 2501 | 0.73 | 2.33 | X7R |
| Example108 | 5.70 | 31.40 | 2573 | 0.86 | 2.32 | X7R |
| Example109 | 5.64 | 30.38 | 2690 | 0.77 | 2.19 | X7R |
| Example110 | 5.50 | 28.68 | 2941 | 0.89 | 2.25 | X7R |
| Example111 | 5.17 | 24.04 | 2573 | 0.96 | 2.08 | X7R |
| Example112 | 5.80 | 33.23 | 2292 | 0.79 | 3.49 | X7R |
| Example113 | 5.80 | 33.08 | 2291 | 0.69 | 3.31 | X7R |
| Example114 | 5.80 | 32.94 | 2323 | 0.71 | 3.24 | X7R |
| Example115 | 5.02 | 21.05 | 2455 | 0.90 | 2.28 | X7R |
| Example116 | 5.35 | 26.55 | 2622 | 0.87 | 2.20 | X7R |
| Example117 | 5.40 | 27.17 | 2558 | 0.80 | 2.11 | X7R |
| Example118 | 5.43 | 27.89 | 2727 | 0.82 | 2.15 | X7R |
| Example119 | 5.45 | 28.37 | 2843 | 0.76 | 2.16 | X7R |
| Example120 | 5.50 | 28.68 | 2941 | 0.89 | 2.25 | X7R |
| Example121 | 5.51 | 29.10 | 2901 | 0.86 | 2.30 | X7R |

### Examples 122 to 163

A nylon pot having a volume of 700 ml was charged with 1150 g of ZrO₂ balls (diameter 5 mm), and a total of 60 g of a ceramic raw material powder, a glass powder, and an accessory component element-containing compound powder in a blending proportion shown in Table 16, and then charged with 95 g of ethanol. A pot mill was operated at 80 rpm for 2 hours to obtain a slurry. Then, the ZrO₂ balls were separated from the slurry, and then, the total amount of the slurry was dried to obtain a dielectric ceramic-forming sample.

10 g of the obtained dielectric ceramic-forming sample was weighed, and 1.3 g of a 5% by weight solution of a polyvinyl acetal resin (a mixed solvent with toluene:n-butanol=6:4) was added. They were sufficiently mixed in a mortar to obtain a granulated material. The obtained granulated material was strained through a nylon sieve having a mesh size of 150 μm, and then dried at 80° C. for 1 hour to obtain a dried product.

Then, the obtained dried product was subjected to uniaxial pressing at a pressure of 470 MPa using an 11.5 mm φ cemented carbide die to obtain a disk-shaped formed body.

Finally, the obtained disk-shaped formed body was heated in an air atmosphere to firing temperature shown in Table 16 at a rate of 200° per hour, maintained as it was for 2 hours, and then cooled to obtain a dielectric ceramic sample.

TABLE 16

| | Accessory com- | | | | | |
|---|---|---|---|---|---|---|
| | ponent element- | | | | | |
| | containing | | Type of | Glass powder | | Firing |
| | compound | | ceramic | | Blending | tem- |
| | | Blending | raw | | amount *²⁾ | pera- |
| | | amount *¹⁾ | material | | (% by | ture |
| | Type | (mole %) | powder | Type | weight) | (° C.) |
| Example122 | c3 | 2.4 | A | m8 | 3 | 850 |
| Example123 | c3 | 2.1 | A | m12 | 3 | 850 |
| Example124 | c3 | 2.1 | A | m12 | 3 | 875 |
| Example125 | c3 | 2.1 | A | m22 | 3 | 850 |
| Example126 | c3 | 2.1 | A | m22 | 3 | 875 |
| Example127 | c3 | 2.2 | A | m22 | 4 | 800 |
| Example128 | c3 | 2.2 | A | m22 | 4 | 825 |
| Example129 | c3 | 2.2 | A | m22 | 4 | 850 |
| Example130 | c3 | 2.2 | A | m22 | 4 | 875 |
| Example131 | c3 | 2.2 | A | m22 | 5 | 800 |
| Example132 | c3 | 2.2 | A | m22 | 5 | 825 |
| Example133 | c3 | 2.2 | A | m22 | 5 | 850 |
| Example134 | c3 | 2.2 | A | m22 | 5 | 875 |
| Example135 | c3 | 2.1 | A | m22 | 5 | 900 |
| Example136 | c3 | 2.4 | A | m22 | 5 | 900 |
| Example137 | c3 | 2.6 | A | m22 | 5 | 900 |
| Example138 | c3 | 2.2 | A | m22 | 6 | 800 |
| Example139 | c3 | 2.2 | A | m22 | 6 | 825 |
| Example140 | c3 | 2.2 | A | m22 | 6 | 850 |
| Example142 | c3 | 2.2 | A | m22 | 6 | 875 |
| Example143 | c3 | 2.1 | A | m22 | 6 | 900 |
| Example144 | c3 | 2.1 | B | m12 | 3 | 850 |
| Example145 | c3 | 2.1 | B | m12 | 3 | 875 |
| Example146 | c3 | 2.1 | B | m22 | 3 | 850 |
| Example147 | c3 | 2.1 | B | m22 | 3 | 875 |
| Example148 | c3 | 2.2 | B | m22 | 5 | 800 |
| Example149 | c3 | 2.2 | B | m22 | 5 | 825 |
| Example150 | c3 | 2.2 | B | m22 | 5 | 850 |
| Example151 | c3 | 2.2 | B | m22 | 5 | 875 |
| Example152 | c3 | 2.2 | B | m22 | 7.5 | 800 |
| Example153 | c3 | 2.2 | B | m22 | 7.5 | 825 |
| Example154 | c3 | 2.2 | B | m22 | 7.5 | 850 |
| Example155 | c3 | 2.2 | B | m22 | 7.5 | 875 |
| Example156 | c3 | 2.2 | B | m22 | 10 | 800 |
| Example157 | c3 | 2.2 | B | m22 | 10 | 825 |
| Example158 | c3 | 2.2 | B | m22 | 10 | 850 |
| Example159 | c3 | 2.2 | B | m22 | 10 | 875 |
| Example160 | d3 | 2.4 | A | m8 | 3 | 860 |
| Example161 | b3 | 2.4 | A | m8 | 3 | 850 |
| Example162 | b3 | 2.2 | A | m8 | 3 | 860 |
| | e3 | 0.1 | | | | |
| Example163 | b3 | 2.1 | A | m9 | 8 | 850 |

*¹⁾ The blending amount of the accessory component element-containing compound powder is the amount (mole %) of the accessory component element with respect to the amount in terms of moles of the ceramic raw material powder.
*²⁾ The blending amount of the glass powder is an amount (% by weight) with respect to the amount of the target dielectric ceramic-forming composition.

### <Characteristics Evaluation>

For the obtained dielectric ceramic samples, sintered density, volume shrinkage rate, relative permittivity, dielectric loss, and temperature characteristics were obtained as in Examples 1 to 21. The results are shown in Table 17.

TABLE 17

| | | | Relative | | | |
|---|---|---|---|---|---|---|
| | | | permit- | Dielectric | | Temper- |
| | Sintered | Volume | tivity | loss | | ature |
| | density | shrinkage | 25° C. | 25° C. | MAX | character- |
| | (g/cm³) | rate (%) | (—) | (%) | (%) | istics |
| Example122 | 5.22 | 24.89 | 2475 | 0.76 | 2.29 | X7R |
| Example123 | 5.19 | 23.44 | 2674 | 0.71 | 1.86 | X7R |
| Example124 | 5.55 | 28.49 | 3313 | 1.72 | 2.35 | X7R |
| Example125 | 5.21 | 24.14 | 2471 | 0.72 | 1.83 | X7R |
| Example126 | 5.47 | 27.59 | 3062 | 0.79 | 2.11 | X7R |
| Example127 | 4.74 | 17.74 | 1532 | 0.86 | 1.58 | X8R |
| Example128 | 5.04 | 22.14 | 2098 | 0.85 | 1.81 | X8R |
| Example129 | 5.42 | 27.70 | 2826 | 0.87 | 2.66 | X7R |
| Example130 | 5.67 | 31.01 | 3098 | 0.89 | 2.43 | X7R |
| Example131 | 4.86 | 19.72 | 1604 | 0.71 | 1.59 | X8R |
| Example132 | 5.17 | 24.08 | 2016 | 0.76 | 1.77 | X8R |
| Example133 | 5.50 | 28.72 | 2617 | 0.84 | 2.24 | X7R |
| Example134 | 5.68 | 31.13 | 2887 | 0.82 | 2.50 | X7R |
| Example135 | 5.78 | 32.97 | 2945 | 0.84 | 2.40 | X7R |
| Example136 | 5.82 | 32.62 | 3383 | 0.75 | 2.65 | X7R |
| Example137 | 5..81 | 32.46 | 3460 | 0.88 | 2.55 | X7R |
| Example138 | 4.99 | 21.90 | 1732 | 0.83 | 1.74 | X8R |
| Example139 | 5.29 | 25.46 | 1962 | 0.68 | 1.71 | X8R |
| Example140 | 5.55 | 29.51 | 2286 | 0.72 | 2.06 | X8R |
| Example142 | 5.69 | 31.27 | 2438 | 0.77 | 2.34 | X7R |
| Example143 | 5.76 | 33.09 | 2807 | 0.93 | 2.47 | X7R |
| Example144 | 5.43 | 28.46 | 2309 | 0.86 | 1.86 | X7R |
| Example145 | 5.68 | 31.51 | 2949 | 0.89 | 2.08 | X7R |
| Example146 | 5.57 | 30.77 | 2333 | 0.73 | 1.85 | X7R |
| Example147 | 5.75 | 32.90 | 2609 | 0.88 | 1.98 | X7R |
| Example148 | 5.25 | 26.78 | 2009 | 1.06 | 1.65 | X8R |
| Example149 | 5.53 | 30.49 | 2406 | 0.92 | 2.00 | X7R |
| Example150 | 5.70 | 32.38 | 2589 | 0.79 | 2.36 | X7R |
| Example151 | 5.79 | 33.43 | 2475 | 0.79 | 2.21 | X7R |
| Example152 | 5.50 | 30.02 | 2056 | 1.53 | 2.10 | X8R |
| Example153 | 5.63 | 31.45 | 1857 | 1.06 | 2.12 | X8R |
| Example154 | 5.73 | 32.88 | 1971 | 0.72 | 2.15 | X8R |
| Example155 | 5.75 | 33.26 | 2072 | 0.78 | 2.47 | X7R |
| Example156 | 5.60 | 31.39 | 1936 | 0.72 | 1.97 | X8R |
| Example157 | 5.69 | 32.46 | 2009 | 0.71 | 2.24 | X8R |
| Example158 | 5.76 | 33.25 | 1833 | 0.68 | 2.34 | X8R |
| Example159 | 5.75 | 33.52 | 1883 | 0.75 | 2.72 | X7R |
| Example160 | 5.69 | 30.56 | 3387 | 0.87 | 2.35 | X7R |
| Example161 | 5.51 | 28.69 | 2858 | 0.82 | 2.29 | X7R |
| Example162 | 5.59 | 30.08 | 3113 | 0.78 | 2.20 | X7R |
| Example163 | 5.71 | 32.92 | 2132 | 0.81 | 2.75 | X7R |

### INDUSTRIAL APPLICABILITY

Even if the dielectric ceramic-forming composition according to the present invention is sintered at temperature lower than conventional temperature, a dielectric ceramic material having high relative permittivity can be obtained. Therefore, in addition to being used as dielectric materials for thin-layer ceramic capacitors, the obtained dielectric ceramic material can also be preferably used as dielectric materials for electronic components, such as printed wiring boards, multilayer printed wiring boards, electrode ceramic circuit boards, glass ceramic circuit boards, circuit peripheral materials, inorganic ELs, and plasma displays.

1. A dielectric ceramic-forming composition comprising a perovskite (ABO₃)-type ceramic raw material powder, and a glass powder containing, on an oxide basis, 35% by weight to 90% by weight of Bi₂O₃, 2.5% by weight to 20% by weight of ZnO, 1% by weight to 20% by weight of B₂O₃, 0.5% by weight to 15% by weight of SiO₂, 0.5% by weight to 15% by weight of an alkali metal oxide, and 0.1% by weight to 35% by weight of an alkaline earth metal oxide, wherein 1% by weight to 15% by weight of the glass powder is blended with respect to the dielectric ceramic-forming composition.

2. The dielectric ceramic-forming composition according to claim 1, wherein an average particle diameter of the perovskite (ABO₃)-type ceramic raw material powder is 0.1 μm to 2 μm.

3. The dielectric ceramic-forming composition according to claim 1, wherein a BET specific surface area of the perovskite (ABO₃)-type ceramic raw material powder is 1.0 m²/g or more.

4. The dielectric ceramic-forming composition according to claim 1, wherein the glass powder further contains, on an oxide basis, 0.1% by weight to 5% by weight of CuO.

5. The dielectric ceramic-forming composition according to claim 1, wherein the glass powder is a mixture of a first glass powder containing Bi₂O₃ and ZnO as components and a second glass powder containing B₂O₃, SiO₂, an alkali metal oxide, and an alkaline earth metal oxide as components.

6. The dielectric ceramic-forming composition according to claim 5, wherein the second glass powder contains B₂O₃, SiO₂, Li₂O, BaO, and CaO as components.

7. The dielectric ceramic-forming composition according to claim 5, wherein a weight ratio of the first glass powder to the second glass powder is in the range of 20:1 to 1:1.

8. The dielectric ceramic-forming composition according to claim 1, wherein an A-site element of the perovskite (ABO₃)-type ceramic raw material powder is at least one selected from the group consisting of Ba, Ca, and Sr, and a B-site element is at least one selected from the group consisting of Ti and Zr.

9. The dielectric ceramic-forming composition according to claim 1, wherein the perovskite (ABO₃)-type ceramic raw material powder is barium titanate.

10. The dielectric ceramic-forming composition according to claim 1, further comprising an accessory component element-containing compound powder containing at least one accessory component element selected from the group consisting of rare earth elements consisting of Sc, Y, La, Ce, Pr, Nd, Sm, Eu, Gd, Tb, Dy, Ho, Er, Tm, Yb, and Lu, Mg, Ca, Sr, Zr, Hf, V, Nb, Ta, Mn, Cr, Mo, and W.

11. A dielectric ceramic material obtained by firing a dielectric ceramic-forming composition according to claim 1.

12. The dielectric ceramic material according to claim 11, wherein the firing is performed at 1000° C. or lower.

13. The dielectric ceramic material according to claim 11, wherein relative permittivity at a frequency of 1 kHz is 500 or more.

14. The dielectric ceramic material according to claim 11, wherein dielectric loss at a frequency of 1 kHz is 5% or less.

15. The dielectric ceramic-forming composition according to claim 6, wherein a weight ratio of the first glass powder to the second glass powder is in the range of 20:1 to 1:1.

16. A dielectric ceramic material obtained by firing a dielectric ceramic-forming composition according to claim 5.

17. A dielectric ceramic material obtained by firing a dielectric ceramic-forming composition according to claim 8.

18. A dielectric ceramic material obtained by firing a dielectric ceramic-forming composition according to claim 10.

19. The dielectric ceramic material according to claim 12, wherein relative permittivity at a frequency of 1 kHz is 500 or more.

20. The dielectric ceramic material according to claim 12, wherein dielectric loss at a frequency of 1 kHz is 5% or less.
